(19) United States
(12) Patent Application Publication
(10) Pub. No.: US 2026/0135385 A1
(43) Pub. Date: May 14, 2026

(54) A SYSTEM AND A METHOD FOR ENABLING PARALLEL DISTRIBUTION OF POWER TO SCALE ELECTRICAL COMPONENTS

(71) Applicants: Ryan Evaristo Pinto, Goa (IN); Sujay Ramnath Shirodkar, Goa (IN)

(72) Inventors: Ryan Evaristo Pinto, Goa (IN); Sujay Ramnath Shirodkar, Goa (IN)

(21) Appl. No.: 19/118,383

(22) PCT Filed: Nov. 17, 2022
(86) PCT No.: PCT/IB2022/061068

§ 371 Date: Apr. 4, 2025

(30) Foreign Application Priority Data
Oct. 7, 2022 (IN) 202221057489
Nov. 17, 2022 (WO) PCT/IB2022/061068

(51) Int. Cl. H02J 3/007; H02P 25/03

(52) U.S. Cl. CPC H02J 3/007; H02P 25/03

(57) ABSTRACT

The system 10 includes a winding distribution unit 20 to provide a first plurality of leads, a second plurality of leads, and a third plurality of leads from a motor 50. The first plurality of leads includes a first lead 60, a second lead 70, and a third lead. The second plurality of leads includes a fourth lead, a fifth lead, and a sixth lead. The third plurality of leads includes a seventh lead, an eighth lead, and a ninth lead. The system includes a driving unit including a first driver to provide first pulses to the first lead, the fourth lead, and the seventh lead. The driving unit includes a second driver to provide second pulses to the second lead, the fifth lead, and the eighth lead. The driving unit includes a third driver to provide third pulses to the third lead, the sixth lead, and the ninth lead.

### EARLIEST PRIORITY DATE

This Application claims priority from a complete patent application filed in India having Patent Application No. 202221057489, filed on Oct. 7, 2022, and titled “A SYSTEM AND A METHOD FOR ENABLING PARALLEL DISTRIBUTION OF POWER TO SCALE ELECTRICAL COMPONENTS” and a PCT Application no. PCT/IB2022/061068 filed on Nov. 17, 2022, and titled “A SYSTEM AND A METHOD FOR ENABLING PARALLEL DISTRIBUTION OF POWER TO SCALE ELECTRICAL COMPONENTS”

### FIELD OF INVENTION

Embodiments of the present disclosure relate to the field of electrical windings and more particularly to a system and a method for enabling parallel distribution of power to scale electrical components.

### BACKGROUND

Electric equipment such as motors, transformers and inductors, operate on the principles of electromagnetism. In particular, the Ampere-Maxwell law states that the strength of the magnetic field around a conductor is directly proportional to the magnitude of the electric current flowing through the conductor. The motors, the transformers, electromagnets, and the inductors are composed of one or more windings or coils that carry electric current and thus generate the magnetic fields necessary to carry out their respective functions. Consequently, electromagnetic devices of higher power ratings require the supply and control of large amounts of current and/or voltage and/or power.

Current technology to drive such electromagnetic coils with large amount of current and power employ expensive individual components and combine them in very specialized and expensive ways raising the complexity and costs of drivers of such high powered electromagnetic equipment.

Hence, there is a need for an improved system and a method for enabling parallel distribution of power to scale electrical components to address the aforementioned issue(s).

### BRIEF DESCRIPTION

In accordance with an embodiment of the present disclosure, a system for enabling parallel distribution of power to scale electrical components is provided. The system includes a winding distribution unit adapted to provide a first plurality of leads from a first winding set of a motor by creating corresponding first plurality of parallel paths in the first winding set of the motor. The first plurality of leads includes a first lead, a second lead, and a third lead. The winding distribution unit is also adapted to provide a second plurality of leads from a second winding set of the motor by creating corresponding second plurality of parallel paths in the second winding set of the motor. The second plurality of leads includes a fourth lead, a fifth lead, and a sixth lead. The winding distribution unit is further adapted to provide a third plurality of leads from a third winding set of the motor by creating corresponding third plurality of parallel paths in the third winding set of the motor. The third plurality of leads includes a seventh lead, an eighth lead, and a ninth lead. The system also includes a driving unit electrically coupled to the winding distribution unit. The driving unit includes a first driver adapted to provide a first plurality of pulses to the first lead, the fourth lead, and the seventh lead to drive the motor. The driving unit also includes a second driver adapted to provide a second plurality of pulses to the second lead, the fifth lead, and the eighth lead to drive the motor. The driving unit further includes a third driver adapted to provide a third plurality of pulses to the third lead, the sixth lead, and the ninth lead to drive the motor. The first driver, the second driver, and the third driver are adapted to provide the corresponding first plurality of pulses, the second plurality of pulses and the third plurality of pulses simultaneously by maintaining a predefined time delay between the corresponding first plurality of pulses, the second plurality of pulses and the third plurality of pulses, thereby enabling parallel distribution of power.

In accordance with another embodiment of the present disclosure, a method for enabling parallel distribution of power to scale electrical components is provided. The method includes providing, by a winding distribution unit, a first plurality of leads from a first winding set of a motor by creating corresponding first plurality of parallel paths in the first winding set of the motor. The first plurality of leads includes a first lead, a second lead, and a third lead. The method also includes providing, by the winding distribution unit, a second plurality of leads from a second winding set of the motor by creating corresponding second plurality of parallel paths in the second winding set of the motor. The second plurality of leads includes a fourth lead, a fifth lead, and a sixth lead. The method further includes providing, by the winding distribution unit, a third plurality of leads from a third winding set of the motor by creating corresponding third plurality of parallel paths in the third winding set of the motor. The third plurality of leads includes a seventh lead, an eighth lead, and a ninth lead. The method also includes providing, by a first driver, a first plurality of pulses to the first lead, the fourth lead, and the seventh lead to drive the motor. The method also includes providing, by a second driver, a second plurality of pulses to the second lead, the fifth lead, and the eighth lead to drive the motor. The method further includes providing, by a third driver, a third plurality of pulses to the third lead, the sixth lead, and the ninth lead to drive the motor. The first driver, the second driver, and the third driver are adapted to provide the corresponding first plurality of pulses, the second plurality of pulses and the third plurality of pulses simultaneously by maintaining a predefined time delay between the corresponding first plurality of pulses, the second plurality of pulses and the third plurality of pulses.

To further clarify the advantages and features of the present disclosure, a more explicit description of the disclosure will follow by reference to specific embodiments thereof, which are illustrated in the appended figures. It is to be appreciated that these figures depict typical embodiments of the disclosure and are therefore not to be considered limiting in scope. The disclosure will be described and explained with additional details with the appended figures.

### BRIEF DESCRIPTION OF THE DRAWINGS

The disclosure will be described and explained with additional specificity and detail with the accompanying figures in which:

FIG. 1 is a schematic representation of a system for enabling parallel distribution of power to scale electrical components in accordance with an embodiment of the present disclosure;

FIG. 2 is a schematic representation of one embodiment of a system of FIG. 1, depicting operational arrangement of a winding distribution unit with a transformer in accordance with an embodiment of the present disclosure;

FIG. 3 is a schematic representation of another embodiment of a system of FIG. 1, depicting operational arrangement of the winding distribution unit with an inductor in accordance with an embodiment of the present disclosure;

FIG. 4(a) is a flow chart representing the steps involved in a method for enabling parallel distribution of power to scale electrical components in accordance with an embodiment of the present disclosure; and

FIG. 4(b) is a flow chart representing the continued steps involved in a method of FIG. 4(a), in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

To promote an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for enabling parallel distribution of power to scale electrical components. The system includes a winding distribution unit adapted to provide a first plurality of leads from a first winding set of a motor by creating corresponding first plurality of parallel paths in the first winding set of the motor. The first plurality of leads includes a first lead, a second lead, and a third lead. The winding distribution unit is also adapted to provide a second plurality of leads from a second winding set of the motor by creating corresponding second plurality of parallel paths in the second winding set of the motor. The second plurality of leads includes a fourth lead, a fifth lead, and a sixth lead. The winding distribution unit is further adapted to provide a third plurality of leads from a third winding set of the motor by creating corresponding third plurality of parallel paths in the third winding set of the motor. The third plurality of leads includes a seventh lead, an eighth lead, and a ninth lead. The system also includes a driving unit electrically coupled to the winding distribution unit. The driving unit includes a first driver adapted to provide a first plurality of pulses to the first lead, the fourth lead, and the seventh lead to drive the motor. The driving unit also includes a second driver adapted to provide a second plurality of pulses to the second lead, the fifth lead, and the eighth lead to drive the motor. The driving unit further includes a third driver adapted to provide a third plurality of pulses to the third lead, the sixth lead, and the ninth lead to drive the motor. The first driver, the second driver, and the third driver are adapted to provide the corresponding first plurality of pulses, the second plurality of pulses and the third plurality of pulses simultaneously by maintaining a predefined time delay between the corresponding first plurality of pulses, the second plurality of pulses and the third plurality of pulses, thereby enabling parallel distribution of power.

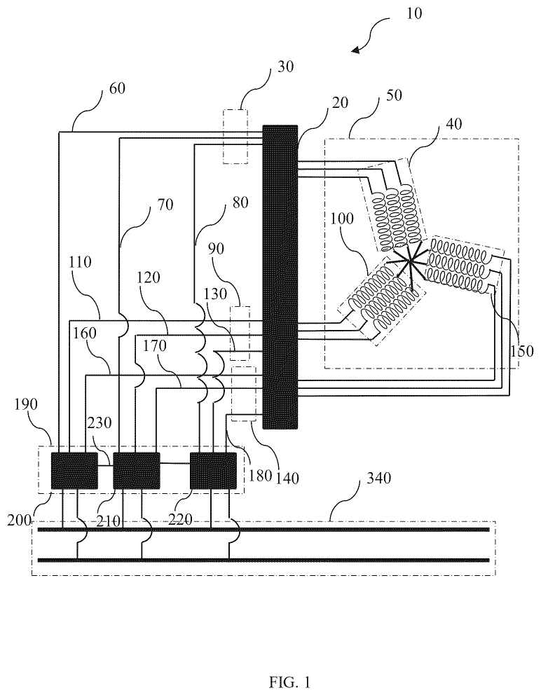

FIG. 1 is a schematic representation of a system 10 for enabling parallel distribution of power to scale electrical components in accordance with an embodiment of the present disclosure. The system 10 includes a winding distribution unit 20 adapted to provide a first plurality of leads 30 from a first winding set 40 of a motor 50 by creating corresponding first plurality of parallel paths in the first winding set 40 of the motor 50. In one embodiment, the motor 50 may include, but not limited to, an alternating current (AC) motor, a direct current (DC) motor, a brushless direct current (BLDC) motor and the like.

Further, the first plurality of leads 30 includes a first lead 60, a second lead 70, and a third lead 80. The winding distribution unit 20 is also adapted to provide a second plurality of leads 90 from a second winding set 100 of the motor 50 by creating corresponding second plurality of parallel paths in the second winding set 100 of the motor 50. The second plurality of leads 90 includes a fourth lead 110, a fifth lead 120, and a sixth lead 130. The winding distribution unit 20 is further adapted to provide a third plurality of leads 140 from a third winding set 150 of the motor 50 by creating corresponding third plurality of parallel paths in the third winding set 150 of the motor 50.

Also, the third plurality of leads 140 includes a seventh lead 160, an eighth lead 170, and a ninth lead 180. The system 10 also includes a driving unit 190 electrically coupled to the winding distribution unit 20. The driving unit 190 includes a first driver 200 adapted to provide a first plurality of pulses to the first lead 60, the fourth lead 110, and the seventh lead 160 to drive the motor 50. In one embodiment, the first driver 200 may be adapted to sense one or more relative positions of one or more corresponding poles of the motor 50 before providing the first plurality of pulses to the first lead 60, the fourth lead 110, and the seventh lead 160. In such an embodiment, the one or more relative positions of the one or more corresponding poles of the motor 50 may be sensed by the first driver 200 upon receiving one or more signals from one or more corresponding hall sensors (not shown in FIG. 1) positioned on a stator (not shown in FIG. 1) of the motor 50.

In detail, the one or more hall sensors may provide either a high pulse or a low pulse depends on the one or more corresponding poles of the motor 50 moving in proximity with the one or more corresponding hall sensors. The driving unit 190 also includes a second driver 210 adapted to provide a second plurality of pulses to the second lead 70, the fifth lead 120, and the eighth lead 170 to drive the motor 50. The driving unit 190 further includes a third driver 220 adapted to provide a third plurality of pulses to the third lead 80, the sixth lead 130, and the ninth lead 180 to drive the motor 50.

Moreover, the first driver 200, the second driver 210, and the third driver 220 are adapted to provide the corresponding first plurality of pulses, the second plurality of pulses and the third plurality of pulses simultaneously by maintaining a predefined time delay between the corresponding first plurality of pulses, the second plurality of pulses and the third plurality of pulses, thereby enabling parallel distribution of power. In one embodiment, the first driver 200 may be adapted to provide one or more synchronization signals to the second driver 210 and the third driver 220 to enable the simultaneous operation of the first driver 200, the second driver 210 and the third driver 220. In such an embodiment, the one or more synchronization signals may be transmitted via an optical fiber cable 230 to reduce latency.

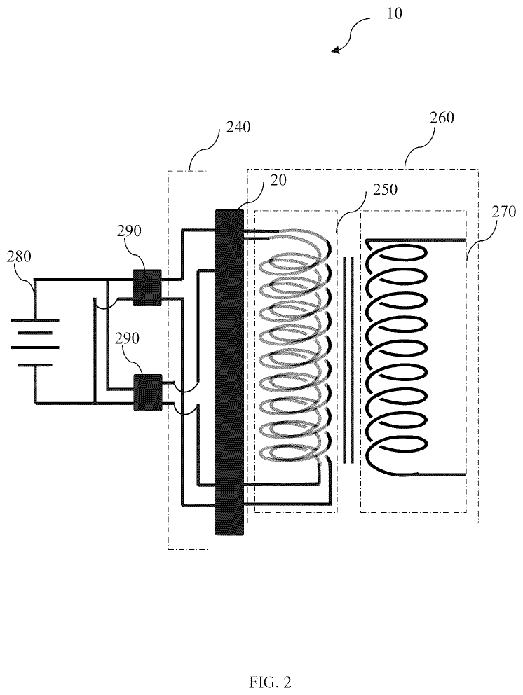

Additionally, in some embodiments, the first lead 60, the fourth lead 110, and the seventh lead 160 receiving the first plurality of pulses, the second lead 70, the fifth lead 120 and the eight lead receiving the second plurality of pulses, the third lead 80, the sixth lead 130, and the ninth lead 180 receiving the third plurality of pulses may be electrically isolated with respect to each other. In one embodiment, the first plurality of pulses, the second plurality of pulses, the third plurality of pulses may include voltage pulses. In a specific embodiment, the first plurality of pulses, the second plurality of pulses, the third plurality of pulses may include current pulses. In one embodiment, the driving unit 190 may derive power from a voltage source 340. Operation of the winding distribution unit 20 in association with a transformer 260 is explained in FIG. 2.

FIG. 2 is a schematic representation of one embodiment of a system 10 of FIG. 1, depicting operational arrangement of the winding distribution with a transformer 260 in accordance with an embodiment of the present disclosure. One or more strands in the winding of the transformer 260 is depicted in primary winding 250. In one embodiment, the winding distribution unit 20 may be adapted to provide a fourth plurality of parallel paths 240 upon being connected to at least one strand of the primary winding 250 of a transformer 260, and a secondary winding 270 of the transformer 260. In such an embodiment, the fourth plurality of parallel paths 240 may be adapted to be supplied by a plurality of corresponding voltage sources 280.

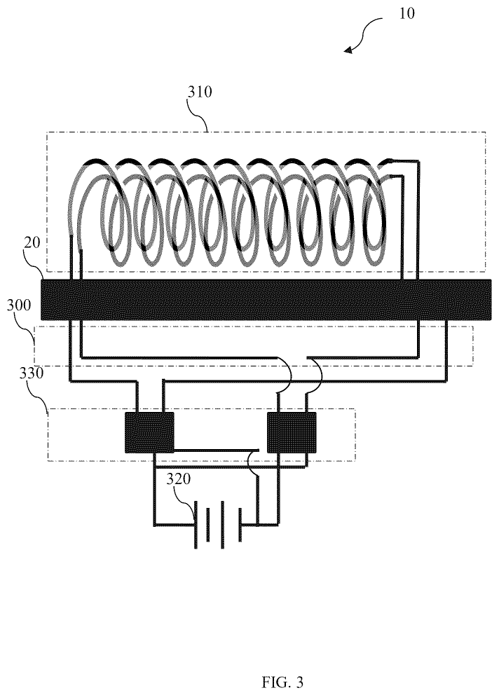

Further, in one embodiment, the plurality of corresponding voltage sources 280 may supply voltage to the fourth plurality of parallel paths 240 via one or more respective drivers 290. In one embodiment, the plurality of corresponding voltage sources 280 are time synchronized. In detail, the plurality of corresponding voltage sources 280 are capable of providing voltage to the fourth plurality of corresponding parallel paths simultaneously. Operation of the winding distribution unit 20 in association with an inductor is explained in FIG. 3.

FIG. 3 is a schematic representation of one embodiment of a system 10 of FIG. 1, depicting operational arrangement of the winding distribution unit 20 with the inductor in accordance with an embodiment of the present disclosure. One or more strands in the winding of the inductor 390 is depicted. In one embodiment, the winding distribution unit 20 may be adapted to provide a fifth plurality of parallel paths upon being connected to an inductor. In such an embodiment, the fifth plurality of parallel paths 300 may adapted to be supplied by a plurality of corresponding power sources 320 via one or more respective drivers 330. In one embodiment, the plurality of corresponding power sources 320 may be time synchronized. In detail, the plurality of corresponding power sources 320 are capable of providing power to the fifth plurality of corresponding parallel paths 300 simultaneously.

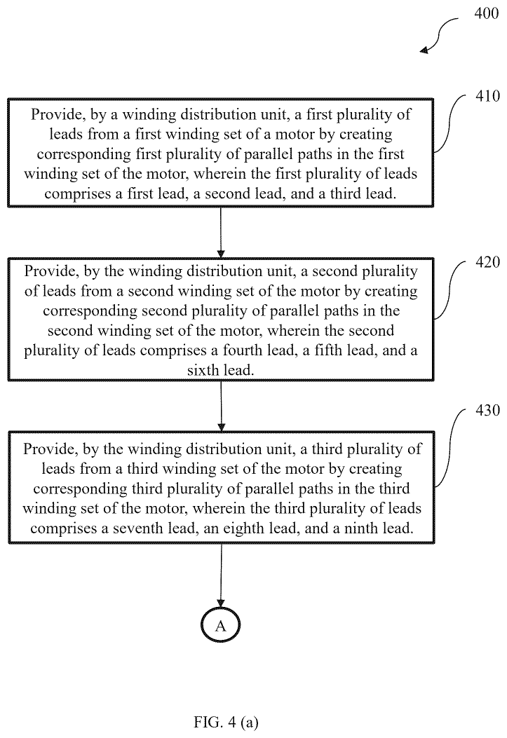

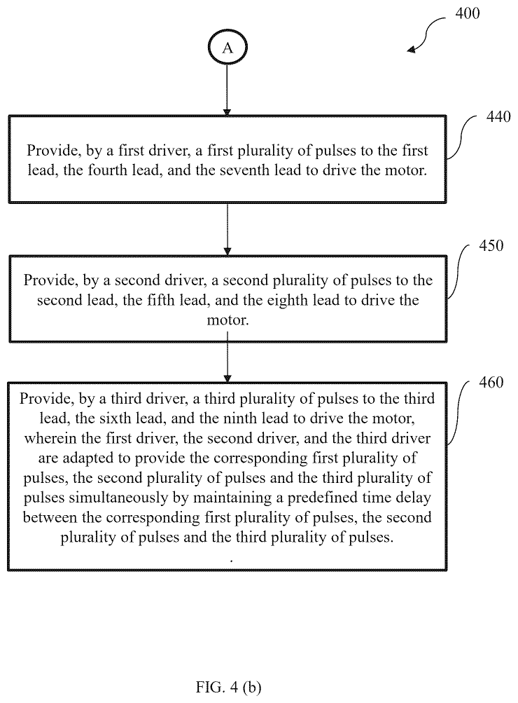

FIG. 4(a) and FIG. 4(b) is a flow chart representing the steps involved in a method 400 for enabling parallel distribution of power to scale electrical components in accordance with an embodiment of the present disclosure. The method 400 includes providing a first plurality of leads from a first winding set of a motor by creating corresponding first plurality of parallel paths in the first winding set of the motor in step 410. In one embodiment, providing a first plurality of leads from a first winding set of a motor by creating corresponding first plurality of parallel paths in the first winding set of the motor includes providing a first plurality of leads from a first winding set of a motor by creating corresponding first plurality of parallel paths in the first winding set of the motor by a winding distribution unit. The first plurality of leads includes a first lead, a second lead, and a third lead. In one embodiment, the motor may include, but not limited to, an alternating current (AC) motor, a direct current (DC) motor, a brushless direct current (BLDC) motor and the like.

The method 400 also includes providing a second plurality of leads from a second winding set of the motor by creating corresponding second plurality of parallel paths in the second winding set of the motor in step 420. In one embodiment, providing a second plurality of leads from a second winding set of the motor by creating corresponding second plurality of parallel paths in the second winding set of the motor includes providing a second plurality of leads from a second winding set of the motor by creating corresponding second plurality of parallel paths in the second winding set of the motor by the winding distribution unit. The second plurality of leads includes a fourth lead, a fifth lead, and a sixth lead.

The method 400 also includes providing a third plurality of leads from a third winding set of the motor by creating corresponding third plurality of parallel paths in the third winding set of the motor in step 430. In one embodiment, providing a third plurality of leads from a third winding set of the motor by creating corresponding third plurality of parallel paths in the third winding set of the motor includes providing a third plurality of leads from a third winding set of the motor by creating corresponding third plurality of parallel paths in the third winding set of the motor by the winding distribution unit. The third plurality of leads includes a seventh lead, an eighth lead, and a ninth lead.

The method 400 also includes providing a first plurality of pulses to the first lead, the fourth lead, and the seventh lead to drive the motor in step 440. In one embodiment, providing a first plurality of pulses to the first lead, the fourth lead, and the seventh lead to drive the motor includes providing a first plurality of pulses to the first lead, the fourth lead, and the seventh lead to drive the motor by a first driver. In one embodiment, the first driver may be adapted to sense one or more relative positions of one or more corresponding poles of the motor before providing the first plurality of pulses to the first lead, the fourth lead, and the seventh lead. In such an embodiment, the one or more relative positions of the one or more corresponding poles of the motor may be sensed by the first driver upon receiving one or more signals from one or more corresponding hall sensors positioned on a stator of the motor.

The method 400 also includes providing a second plurality of pulses to the second lead, the fifth lead, and the eighth lead to drive the motor in step 450. In one embodiment, providing a second plurality of pulses to the second lead, the fifth lead, and the eighth lead to drive the motor includes providing a second plurality of pulses to the second lead, the fifth lead, and the eighth lead to drive the motor by a second driver.

The method 400 further includes providing a third plurality of pulses to the third lead, the sixth lead, and the ninth lead to drive the motor in step 460. In one embodiment, providing a third plurality of pulses to the third lead, the sixth lead, and the ninth lead to drive the motor includes providing a third plurality of pulses to the third lead, the sixth lead, and the ninth lead to drive the motor by a third driver. the first driver, the second driver, and the third driver are adapted to provide the corresponding first plurality of pulses, the second plurality of pulses and the third plurality of pulses simultaneously by maintaining a predefined time delay between the corresponding first plurality of pulses, the second plurality of pulses and the third plurality of pulses.

Further, in one embodiment, the first driver may be adapted to provide one or more synchronization signals to the second driver and the third driver to enable the simultaneous operation of the first driver, the second driver and the third driver. In such an embodiment, the one or more synchronization signals may be transmitted via an optical fiber cable to reduce latency. In some embodiments, the first lead, the fourth lead, and the seventh lead receiving the first plurality of pulses, the second lead, the fifth lead and the eight lead receiving the second plurality of pulses, the third lead, the sixth lead, and the ninth lead receiving the third plurality of pulses may be electrically isolated with respect to each other.

Furthermore, in one embodiment, the first plurality of pulses, the second plurality of pulses, the third plurality of pulses may include voltage pulses. In a specific embodiment, the first plurality of pulses, the second plurality of pulses, the third plurality of pulses may include current pulses. In one embodiment, the winding distribution unit may be adapted to provide a fourth plurality of parallel paths upon being connected to at least one of a primary winding of a transformer, and a secondary winding of the transformer. In such an embodiment, the fourth plurality of parallel paths may adapted to be supplied by a plurality of corresponding voltage sources.

Also, in one embodiment, the plurality of corresponding voltage sources are time synchronized. In one embodiment, the winding distribution unit may be adapted to provide a fifth plurality of parallel paths upon being connected to an inductor. In such an embodiment, the fifth plurality of parallel paths may adapted to be supplied by a plurality of corresponding power sources. In one embodiment, the plurality of power sources may be time synchronized.

Various embodiments of the system and a method for enabling parallel distribution of power to scale electrical components described above enable various advantages. Provision of the distributed driving units enables simultaneous supply of voltage to the respective parallel paths, thereby ensuring operational redundancy and reliability of the electrical equipment. Apart from that, the driving unit may incorporate drivers with lower current and/or voltage and/or wattage ratings to drive the electrical equipment, thereby reducing cost of the drivers. The system is simple, easy to set up and operate.

It will be understood by those skilled in the art that the foregoing general description and the following detailed description are exemplary and explanatory of the disclosure and are not intended to be restrictive thereof. While specific language has been used to describe the disclosure, any limitations arising on account of the same are not intended.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and is not limited to the manner described herein. Moreover, the actions of any flow diagram need not be implemented in the order shown; nor do all the acts need to be necessarily performed. Also, those acts that are not dependent on other acts may be performed in parallel with the other acts. The scope of embodiments is by no means limited by these specific examples.

I claim:

1. A system for enabling parallel distribution of power to scale electrical components comprising:
a winding distribution unit adapted to:
provide a first plurality of leads from a first winding set of a motor by creating corresponding first plurality of parallel paths in the first winding set of the motor, wherein the first plurality of leads comprises a first lead, a second lead, and a third lead ;
provide a second plurality of leads from a second winding set of the motor by creating corresponding second plurality of parallel paths in the second winding set of the motor, wherein the second plurality of leads comprises a fourth lead, a fifth lead, and a sixth lead ;
provide a third plurality of leads from a third winding set of the motor by creating corresponding third plurality of parallel paths in the third winding set of the motor, wherein the third plurality of leads comprises a seventh lead, an eighth lead, and a ninth lead;
a driving unit electrically coupled to the winding distribution unit, wherein the driving unit comprises:
a first driver adapted to provide a first plurality of pulses to the first lead, the fourth lead, and the seventh lead to drive the motor;
a second driver adapted to provide a second plurality of pulses to the second lead the fifth lead, and the eighth lead to drive the motor (50); and
a third driver adapted to provide a third plurality of pulses to the third lead, the sixth lead, and the ninth lead to drive the motor,
wherein the first driver, the second driver, and the third driver are adapted to provide the corresponding first plurality of pulses, the second plurality of pulses and the third plurality of pulses simultaneously by maintaining a predefined time delay between the corresponding first plurality of pulses, the second plurality of pulses and the third plurality of pulses, thereby enabling parallel distribution of power.

2. The system as claimed in claim 1, wherein the motor comprises a brushless direct current motor.

3. The system as claimed in claim 1, wherein the first driver is adapted to sense one or more relative positions of one or more corresponding poles of the motor before providing the first plurality of pulses to the first lead, the fourth lead, and the seventh lead, wherein the one or more relative positions of the one or more corresponding poles of the motor is sensed by the first driver upon receiving one or more signals from one or more corresponding hall sensors positioned on a stator of the motor.

4. The system as claimed in claim 1, wherein the first driver is adapted to provide one or more synchronization signals to the second driver and the third driver to enable the simultaneous operation of the first driver, the second driver and the third driver, wherein the one or more synchronization signals are transmitted via an optical fiber cable to reduce latency.

5. The system as claimed in claim 1, wherein the first lead, the fourth lead, and the seventh lead receiving the first plurality of pulses, the second lead, the fifth lead and the eight lead receiving the second plurality of pulses, the third lead, the sixth lead, and the ninth lead receiving the third plurality of pulses are electrically isolated with respect to each other.

6. The system as claimed in claim 1, wherein the winding distribution unit is adapted to provide a fourth plurality of parallel paths upon being connected to at least one of a primary winding of a transformer, and a secondary winding of the transformer, wherein the fourth plurality of parallel paths are adapted to be supplied by a plurality of corresponding voltage sources.

7. The system as claimed in claim 6, wherein the plurality of corresponding voltage sources are time synchronized.

8. The system as claimed in claim 1, wherein the winding distribution unit is adapted to provide a fifth plurality of parallel paths upon being connected to an inductor, wherein the fifth plurality of parallel paths are adapted to be supplied by a plurality of corresponding power sources.

9. The system as claimed in claim 8, wherein the plurality of corresponding power sources are time synchronized.

10. A method for enabling parallel distribution of power to scale electrical components:
providing, by a winding distribution unit, a first plurality of leads from a first winding set of a motor by creating corresponding first plurality of parallel paths in the first winding set of the motor, wherein the first plurality of leads comprises a first lead, a second lead, and a third lead;
providing, by the winding distribution unit, a second plurality of leads from a second winding set of the motor by creating corresponding second plurality of parallel paths in the second winding set of the motor, wherein the second plurality of leads comprises a fourth lead, a fifth lead, and a sixth lead;
providing, by the winding distribution unit, a third plurality of leads from a third winding set of the motor by creating corresponding third plurality of parallel paths in the third winding set of the motor, wherein the third plurality of leads comprises a seventh lead, an eighth lead, and a ninth lead;
providing, by a first driver, a first plurality of pulses to the first lead, the fourth lead, and the seventh lead to drive the motor;
providing, by a second driver, a second plurality of pulses to the second lead, the fifth lead, and the eighth lead to drive the motor; and
providing, by a third driver, a third plurality of pulses to the third lead, the sixth lead, and the ninth lead to drive the motor, wherein the first driver, the second driver, and the third driver are adapted to provide the corresponding first plurality of pulses, the second plurality of pulses and the third plurality of pulses simultaneously by maintaining a predefined time delay between the corresponding first plurality of pulses, the second plurality of pulses and the third plurality of pulses.
